(19) United States
(12) Patent Application Publication
(10) Pub. No.: US 2016/0325305 A1
(43) Pub. Date: Nov. 10, 2016

(54) UNIVERSAL METHOD, DEVICE AND MATERIALS FOR FIXATING AN INSERT TO A SUBSTRATE

(71) Applicant: Reuven HUGI, Nahariya (IL)

(72) Inventor: Reuven HUGI, Nahariya (IL)

(21) Appl. No.: 15/109,875

(22) PCT Filed: Jan. 7, 2015
(86) PCT No.: PCT/IL2015/050030

§ 371 Date: Jul. 6, 2016

Related U.S. Application Data
(60) Provisional application No. 61/924,300, filed on Jan. 7, 2014.

(51) Int. Cl. B05C 17/005; B29C 65/52; F16B 13/14

(52) U.S. Cl. CPC B05C 17/00543; B05C 17/00553; B05C 17/00596; F16B 13/141; B29C 65/524; B29L 2031/727

(57) ABSTRACT

Universal device, method and tool for allowing installation of bolts in substrates such as building block, concrete and gypsum walls without having to adapt a drill to an anchor and an anchor to a bolt. Bolts of large variety of sizes may be installed using the method, tool and materials of the invention using a single diameter drill, while allowing accurate positioning of the bolt in the substrate even when the installation hole is drilled off the accurate location.

### BACKGROUND OF THE INVENTION

Building construction and home maintenance (do it yourself, DIY) require large usage of nails, bolts and screws for installation and fixation of equipment, articles or objects to substrate of the building, such as walls, ceilings, floors and the like. In substrates such as wood, the installation of a bolt or a screw in the wood is straightforward. In substrates such as concrete, gypsum plate walls and ceilings, concrete block, gravel block and the like, bolts or screws may not be screwed directly into the substrate. Solutions known in the art disclose use of anchors, made of plastic, metal or combinations thereof. The anchors known in the art may be divided into two main groups. The first group includes anchors that are fixed to the substrate based on mechanical friction between the anchor and the substrate, and the second group includes anchors that are fixed to the substrate based on chemical bonding. Reference is made to FIG. 1A which schematically presents anchor 100 inserted into hole 102 made in substrate 104, according to methods known in the art. Screw 106, when screwed into leading hole 100B in anchor 100, presses portion 100A of anchor 100 outwardly against the inner wall of hole 102, thus increasing the friction between anchor 100 and substrate 104.

Reference is made to FIG. 1B which schematically presents anchor 150 adapted to be installed and fixed in hole 152 made in substrate 154, according to methods known in the art. Prior to the insertion of anchor 150 into hole 152 in substrate 154, one or more capsules 158 of chemical bonding materials are inserted into hole 152. Capsules 158 are made of breakable material, such as glass. When anchor 150 is inserted into hole 152, it may hit capsules 158 and break them, causing the materials in the capsules to blend (158A), react, form chemical bond and thus bond anchor 150 to substrate 154. After the bond is fully cured, a bolt may be screwed into anchor 150. Typical curing time is less than 30 seconds for first curing and ˜24 hours for final curing.

As is apparent, the mechanical support that an anchor of the first type may provide is highly dependent on the friction between the anchor and the inner walls of the hole. Most kinds of anchors of the first type apply extended friction force only at part of portion 100A of the anchor. Additional friction, if at all, is provided by the friction between the residual anchor length and the inner walls of the hole and that depends on the accuracy of the drilling that formed the hole, the nature of the substrate, the quality of the drill and other factors. It is common to have a hole drilled for an anchor which is too narrow, in which case it is not usable, or that is too wide—even if only a bit too wide. In such a case, no friction is provided by the portions of the anchor that were not widened by the inserted bolt. A too wide hole also weakens the mechanical resistance to shear and pulling out forces. The use of anchors of the second type requires a good match of the bond capsules to the size of the hole and the size of the anchor (to be inserted before the curing material), as well as curing time. In both types of anchors, there is a high sensitivity to inaccuracy of the location of the hole, because anchors known in the art have an installation hole along their longitudinal axis. As a result, the hole for installation of the anchor is misplaced, and the bolt that will be screwed into it will also be misplaced. In a case where the drilled hole was slightly misplaced, it is usually impossible to fix the problem except by removal of the misplaced anchor, filling the drilled hole and re-doing the process again after the fixed hole was cured.

Other kinds of anchors may also be associated with one of the two main types described above, whether the material of the anchor is made of plastic, metal or a combination thereof; whether the application of the extended friction force is provided in response to the screwing of a bolt into the anchor and thus widening it, or due to the tensioning force applied by the screwing operation acting on two opposite elements of the anchor which in turn widening the anchor.

A third type of anchor may be associated with relatively thin walls where the thickness of the wall and/or its material may not provide large enough friction force and prevent the pulling out of the anchor under the intended operating conditions. Such anchors typically are made to substantially widen at their inner part when the bolt is screwed into the anchor, gaining force by the widened part leaning against the inner face of the thin wall, as known in the art, as illustrated in FIG. 1C.

There is a need for anchoring means that will not need an accurate match of an anchor to a bolt and a drill to an anchor, that will allow easy and fast installation, that will be tolerant of misplaced drilling of the anchor's hole yet allowing accurate location of the bolt fixed in that anchor, that will be universal for a large variety of building materials, that will be easy to apply in the field, etc.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A schematically presents an anchor inserted into hole made in a substrate according to methods known in the art;

FIG. 1B schematically presents an anchor adapted to be installed and fixed in hole made in a substrate according to methods known in the art;

FIG. 1C schematically illustrates an anchor gaining force by its widened part leaning against the inner face of a thin wall, as known in the art;

FIGS. 2A, 2B and 2C schematically depict three consecutive stages of installation of a bolt to a wall according to embodiments of the present invention;

FIG. 2D schematically illustrates application of bolt installation in thin walls, such as gypsum walls, according to embodiments of the present invention;

FIG. 2E is a picture of partial cross section made in a soft brick after a bolt was installed into a hole made in it according to embodiment of the present invention; and

FIG. 3A schematically presents an application tool adapted to provide filling material according to embodiments of the present invention;

FIG. 3B schematically presents an application tool for providing filling material in a form of a double chamber syringe according to some embodiments of the invention;

FIGS. 3C-3D schematically illustrate two cross sections of elongated filling materials according to some embodiments of the invention;

FIGS. 3E-3G schematically illustrate magazines including filling materials according to some embodiments of the invention;

FIGS. 4A-4C schematically illustrates a partial cross section of the nozzle of an application tool according to some embodiments of the present invention.

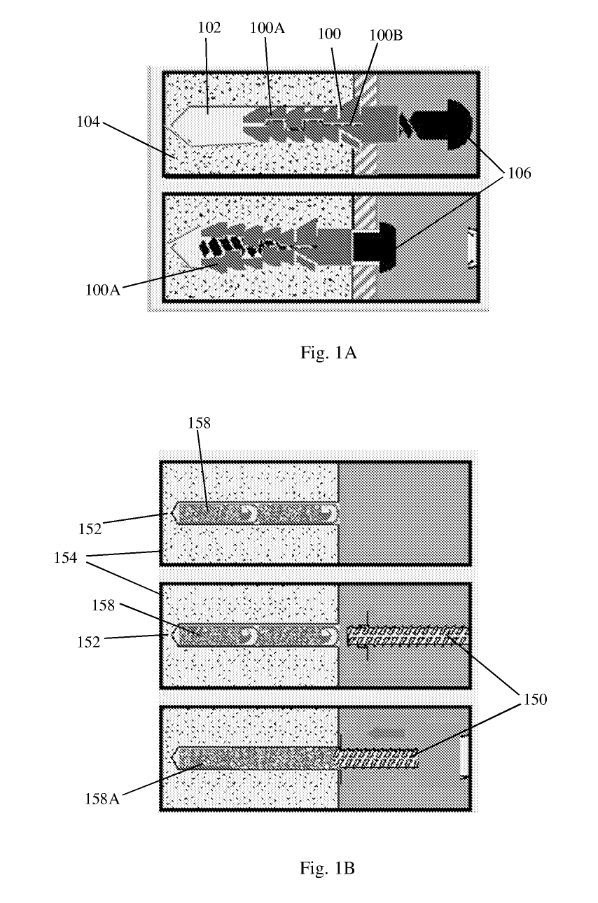

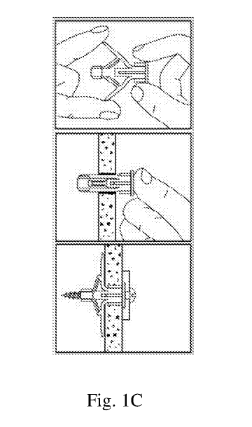

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

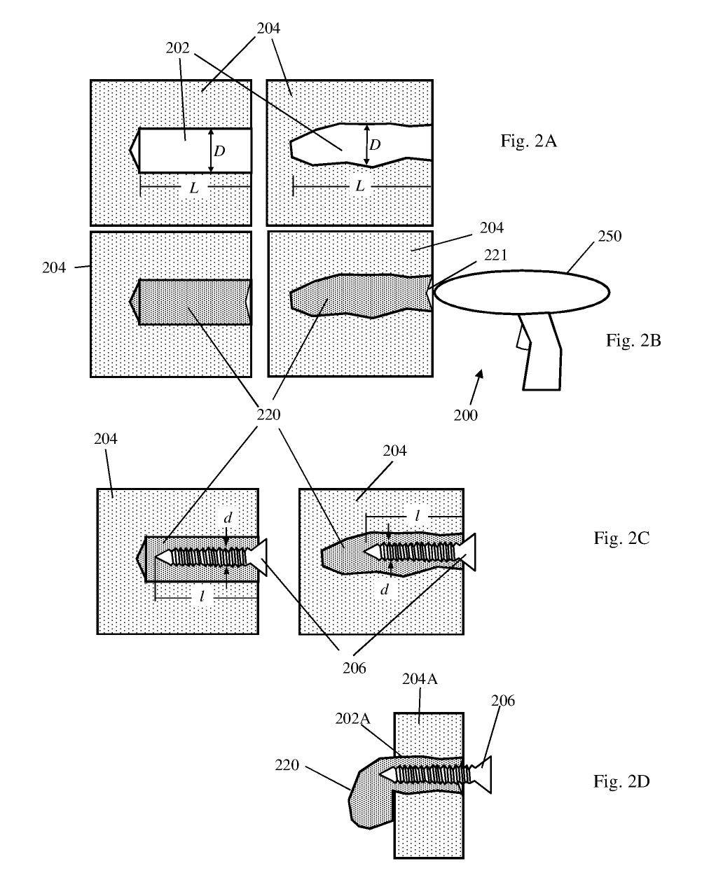

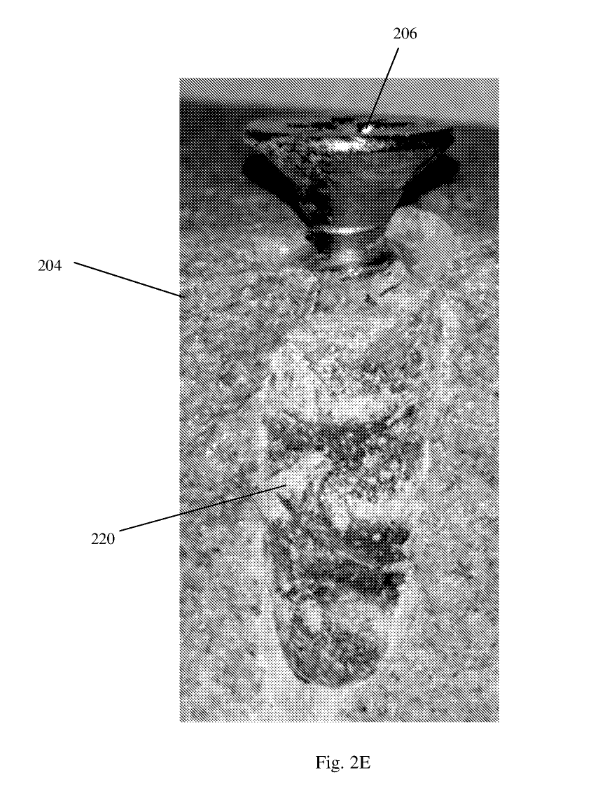

A universal method, device and materials for fixating inserts to a substrate are presented, according to embodiments of the present invention, which may allow using of inserts of wide range of diameters with the same tools and according to the same method of installation. The universal method may include making a hole in the substrate, the substrate may include, for example, a soft/fragile material or of hard material. Reference is made to FIGS. 2A, 2B and 2C, which schematically depict three consecutive stages of installation of insert 206 to substrate (e.g., wall) 204, according to some embodiments of the present invention. Each of drawings FIG. 2A, FIG. 2B and FIG. 2C consists of two frames. The right frame presents the process performed in a substrate made of soft/fragile material, such as gravel material and the left frame presents the same stage of installation performed in a substrate made of hard material, such as concrete. It is assumed that a hole drilled in a wall made of a soft material will be less accurate and with inner walls less smooth than that of a hole drilled in a wall made of hard material. As will be shown, the device, method and materials used for the installation of a bolt in a substrate according to embodiments of the present invention are indifferent as to the material the substrate (e.g., a wall) is made of. Similarly, it will be shown that the installation of an insert in a substrate according to embodiments of the present invention is indifferent as to the exact diameter of the bolt as long as the inner diameter of the hole drilled according to embodiments of the present invention is bigger than the outer diameter of the threads of the bolt.

In order to install insert 206 in substrate, such as wall 204, hole 202 should be drilled or otherwise made in substrate 204. The length (or depth) L of hole 202 needs to be at least in the length 1 of bolt 202 that is to be screwed into the substrate, and the inner diameter D of hole 202 needs to be at least 5% larger than the outer diameter d of the threads of bolt 202. After hole 202 is made, the hole may be filled with a filling material in a flowing state using, for example, an application tool 250 for providing filling material 220 Filling material 220 may include at least one polymeric component. In some embodiments, filling material 220 may have a module of elasticity of at least 16 MPa.

Filling material 220 may be heated to a temperature that makes it soft and close to fluidic phase, thus allowing the filing material to flow easily and fill hole 202.

According to some embodiments, filling material 220 may be one of a variety of thermoplastic materials, that may be selected from, for example, Polycarbonate, Polypropylene, Polyethylene, Polyamides (such as: Nylon 6,6), EVA, ABS etc. Semi-fluidic heated thermoplastic material 220 may be provided and applied into hole 202 until hole 202 is filled to the desired depth, for example to very close to the outer surface of substrate 204, for example, with a shallow recess 221 as seen in FIG. 2B.

Alternatively filling martial 220 may include a first material having a first polymeric component and a second material having a second polymeric component, for example, an epoxy mixture (low hardness level). The first and second materials may be mixed to form filling material 220 prior to filing the hole. For example, a mixed filling material may include low hardness Epoxy resin/Urethane Acrylate resin/Acrylic resin with mixed with a hardener.

In some embodiments, filling material 220 may harden when cold down, for example inside hole 202 in substrate 204. The hardening of filling material 220 is subject to its time-dependent, either a cool-down profile of a heated filling material or cross-linking time of a mixed filling material. A filling material that includes a mixture of a first and a second material may harden when a first polymeric component included in the first material reacts with a second polymeric component included in the second material, for example, forming cross linkages between polymeric chains. In some embodiments, filling material may be configured to harden after no more than 10 minutes, for example, 1-7 minutes, 0.5-3 minutes or less.

According to certain embodiments of the present invention, filling material 220 may be selected according to, among other features, its melt temperature point (Tm) and its hardening temperature point (Tg). For example, filling material may be selected to be polycarbonate with melt flow index (MFI) greater than 30, with or without added fillers (such as wood fibers, calcium carbonate, talc, Wollastonite, crushed thermoset plastic and the like). Polycarbonate has a working temperature between 260 degrees Celsius and 300 degrees Celsius and has a hardening temperature lower than 120 degrees Celsius. For ambient temperature of about 26 degrees Celsius, the cool down time is expected to be shorter than 60 seconds, allowing relatively fast screwing of bolt 206 into the hardened filling material 220. Polycarbonate serving as filling material 220 has shear modulus greater than 0.8 GPa and shear strength greater than 70 MPa, which makes it a fine selection for both applications.

Once filling material 220 has cooled down to the desired temperature/desired level of hardening or at least partially hardens following a chemical reaction, inset 206 may be inserted into it, as seen in FIG. 2C (e.g., a bolt may be screwed into the at least partially hardened filling material). In some embodiments, insert 206 may include at least one of a list consisting of: a bolt, a screw, a nail, a tack and a hook. The operation of inserting insert 206 into filling material 220 causes the following desired results. First, filling material 220 is pressed from the location being gradually employed by insert 206 outwardly towards the inner walls of hole 202, thus applying even greater pressure onto these walls and as a result increasing the friction between filling material 220 and the inner walls of hole 202. Additionally, filling material 220 gains maximal overlapping area with the threads of insert 206, as opposed to plastic or nylon anchors known in the art, where there is a central bore made in them, which reduces the overlapping area of the threads of a bolt which is screwed into the anchor with the anchor's inner face. As a result, the pull-out force for a bolt according to some embodiments of the present invention is greater than that of a bolt screwed into anchor known in the art. Still further, if bolt 206 is screwed into filling material 220 before it has cooled down to ambient temperature, the mere fact of screwing insert 206 into filling material 220 contributes to the cooling of the inner portion of filling material 220 because insert 206, typically made of a material with high heat conductivity coefficient, such as metal, assists in conveying heat from the inner portion of filling material 220 to the ambient, thus speeding the cooling of filling material 220.

Additionally, the method may allow to have a non-centralized hole (i.e., the hole may be elliptic or deviate from a circle at any other way). Such a hole may allow a relatively large degree of freedom in deciding on the exact location of threading of insert 206 into filling material 220, within the borders of hole 202. This eases the job of repairmen and households where exact location of the bolt is of importance.

Reference is made now to FIG. 2D, which schematically illustrates application of insert installation in thin walls 204A, such as gypsum walls, according to some embodiments of the present invention. At the filling stage, filling material 220 may be deposited to an amount that is greater than the amount needed to fill hole 202A. Due to quick cool down of heated filling material 220, when the filling material exceeds the inner end of hole 202A, the filling material starts dripping down but at the same time it hardens (either by cooling or following a chemical reaction), thus creating an L shaped hardened filling material 220 that may strengthen the fixation of filling material 220 to substrate 204A.

Reference is made to FIG. 2E, which is a picture of partial cross section made in a soft brick after insert 206 was installed into a hole made in it according to some embodiment of the present invention. As seen in FIG. 2E, filling material 220 fills fully the hole in soft brick 202, thus providing enhanced gripping of filling material 220 and of bolt 206 to brick 202.

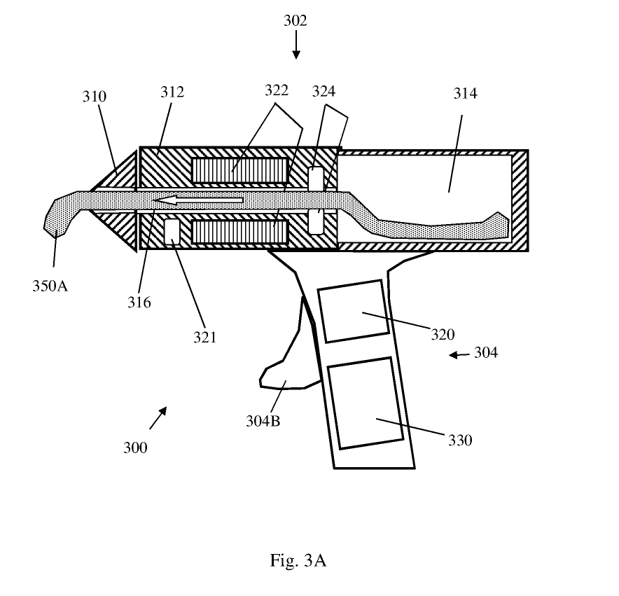

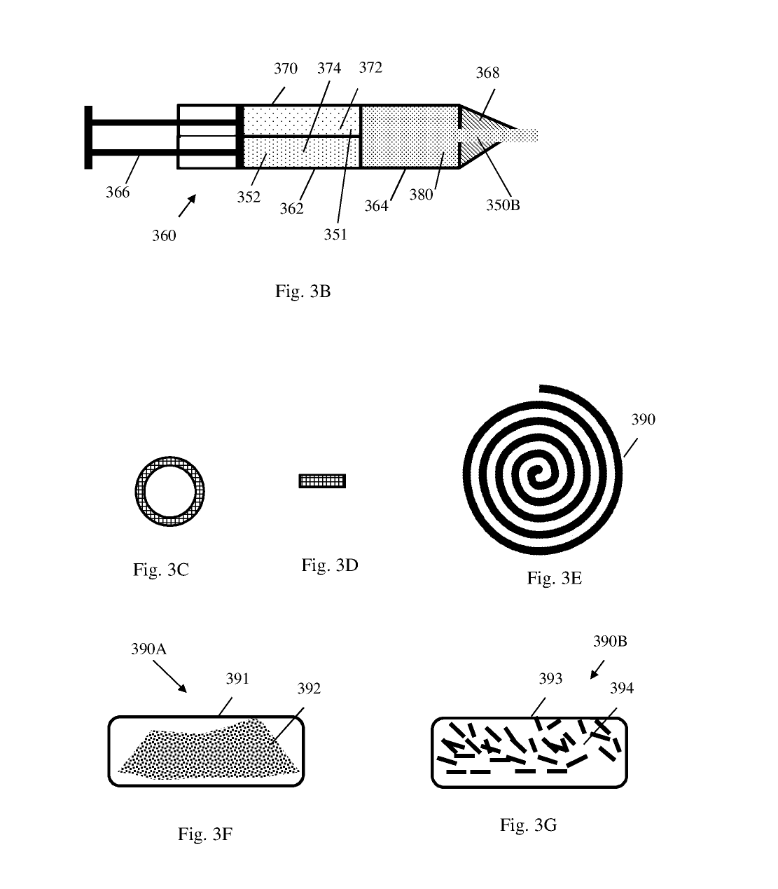

Reference is made now to FIG. 3A, which schematically presents an exemplary application tool 300 adapted to provide filling material according to some embodiments of the invention. Application tool 300 may provide filling material; such as filling material 220 (FIGS. 2A-2E), to holes in a substrate for enabling installation of inserts in the substrate. Application tool 300 may comprise: a chamber 314 for holding a filling material 350A, a preparation unit 312 configured to prepare the filling material, an advancement unit 324 to cause continuous advancement of the filling material and a nozzle 310 for providing the flowing filling material from chamber 314 out of the application tool. Chamber 314, preparation unit 324, advancement unit 324 and nozzle 310 may be included in a main body unit 302 further comprising a handle unit 304, adapted to provide easy and comfortable hold for an operator of application tool 300.

Chamber 314 may be configured to receive a magazine 390 comprising the filling material (e.g., filling material 220). Exemplary magazines 390, 390A and 390B are illustrated and discussed with respect to FIGS. 3E-3G. Magazine 390 may include at least one additional holding chamber for holding filling material, when the filling material is initially in a flowing state or in a form of a powder or flaxes.

Preparation unit 312 may include any system that may enable to prepare filling material 350A to be expelled from toll 300. Preparation unit 312 may include a cylinder 316 and a heating unit 322 for softening/melting filling material 350A to be in a flowing state. Heating unit 322 may be realized in any known manner, such as electrical resistance heating elements, microwave heating units and the like. Heating unit 322 may be adapted to heat filling material 350A to its working temperature, which may be in the range of Polymers melt temperature (for example: Polycarbonate 240-300° C.). The heat transfer capacity of heating unit 322 shall be accorded to the expected capacity of tool 300 and the variety of materials used with tool 300. In some embodiments, preparation unit 312 may further include switch 321 to switch heating unit 322 on and off (e.g., time to heat for work less than 60 seconds).

Advancement unit 324 may comprise any suitable mechanical/electrical unit adapted to cause continuous advancement of the filling material. Unit 324 may controllably feed filling material 350A into cylinder 316 in the desired speed. Advancement unit 324 may include a screw, a piston, a pulley, a cogwheel or the like. Advancement unit 324 may further include a speed control trigger 304B.

In yet another embodiment, trigger 304B may control the speed of operation of tool 300 by controlling the power provided to advancement unit 324 and the advancement speed of advancement unit 324.

Nozzle 310 may provide flowing filling material 350A out of application tool 300. Nozzle 310 may be a replaceable nozzle and may be detached from body 302 to be replaced by a different nozzle 310. Tool 300 may be provided with a set of replaceable nozzles. Each of the replaceable nozzles may have a different outlet diameter, for supplying filling material 350A, at various amounts, for example, different amounts of filling material to fill various holes having different diameters. In some embodiments, application toll 300 may further include a controlling unit 320 for controlling the amount of flowing filling material provided. The operator may select the amount flowing filling material using a dial or a knob located, for example, on handle 304.

Tool 300 may be powered by battery/rechargeable battery, mains cord and the like. For field installations and new building sites, portable dispensing tool may preferably be powered by batteries/rechargeable batteries. Power source 330, adapted to comprise battery/rechargeable battery/mains adapter, may be located, according to embodiments of the present invention in tool handle 304.

Filling material 350A may be kept in a magazine in the form of continuous elongated raw material, possibly having round cross section, hollow tub cross section, or rectangular cross section or the like, as illustrated and discussed with respect to FIGS. 3C-3D. Continuous filling material may be provided, kept and fed to tool 300 rolled in rolls, as illustrated in FIG. 3E. In yet other embodiments, filling material 350 may be kept in the form of elongated bars that are fed, one at a time, into chamber 314 manually. Some exemplary magazines are illustrated and disclosed in FIGS. 3C-3G.

Reference is made to FIG. 3B which schematically presents an exemplary application tool 360 adapted to provide filling material according to some embodiments of the invention. Tool 360 may have a form of a syringe configured to provide filling material 350B that is initially provided to tool 360 in liquid or flowing state. Tool 360 may include a chamber 362 for holding filling material(s) 350B, a preparation unit 364 configured to prepare filling material 350B, an advancement unit 366 to cause continuous advancement of filling material 350B and a nozzle 368 for providing flowing filling material 350B out of application tool 360. In some embodiments, chamber 362 may be configured to receive a magazine 370 comprising filling material(s) 350B that is initially in a flowing state. In some embodiments, filling material 350B may include a first filling material 351 having a first polymeric component and a second material 352 having a second polymeric component. Magazine 370 may include a first holding chamber 372 for holding first material 351 and a second holding chamber 374 for holding second material 352.

In some embodiments, preparation unit 364 may include a chamber 380 for mixing first material 351 and second material 352 to form flowing filling material 350B. first material 351 may be mixed with second material 352 using an additional stirring, for example, a stirrer (not illustrated) located in chamber 380. Alternatively, first material 351 and second material 352 may be mixed by shaking tool 360.

In some embodiment, tool 360 may have a shape of a single chamber syringe and advancement unit 366 may include or may have the shape of at least one plunger for pushing liquid (or flowing) filling material 350B. Filling material 350B may include a single pre-prepared composition (i.e., a composition that is already ready for insertion to a hole). In such case chamber 362 and preparation unit 364 may be included in a single chamber or may be united into a single unit. A single plunger 366 may be configured to push filling material 350B towards nozzle 368.

In some embodiments, tool 360 may have a form of a double chamber syringe and may further include a double chamber magazine 370. In such case, advancement unit 366 may include at least one plunger 366 (having two branches as illustrated in FIG. 3B) for pushing first material 351 held in first chamber 372 and second material 352 held in second chamber 374 into preparation unit 364 to be mixed. In some embodiments, plunger 366 may be pushed manually by an operator holding tool 360. Alternatively, plunger 366 may be automatically pushed by any mechanical and/or electrical device (not illustrated) following a command made by the user, for example, by pressing a button (not illustrated) included in tool 360.

In some embodiments, advancement units 366 or 324 (included in tool 300) may include an electrical and/or a mechanical unit (e.g., control unit 320) adapted to controllably feed filling material into preparation units 364 or 312. The unit may control the amount of filling material that is expelled from tool 300 or 360. In some embodiments, the unit may be tuned and the amount of filling material may be selected by the user, using for example, a button or a dial included in tool 300 or tool 360. In some embodiments, the controlling unit (e.g., unit 320) may include a trigger (e.g., trigger 304B), for controllably feed filling materials 350A and/or 350B and expelling the filling material from tools 300 or 360.

In some embodiments, nozzle 368 may provide flowing filling material 350B out of application tool 360. Nozzle 368 may be a replaceable nozzle and may be detached from tool 360 to be replaced by a different nozzle 368. Tool 360 may be provided with a set of replaceable nozzles 368 each of the replaceable nozzles may have a different outlet diameter, for supplying filling material 350B, at various amounts, for example, in order to fill various holes having different diameters.

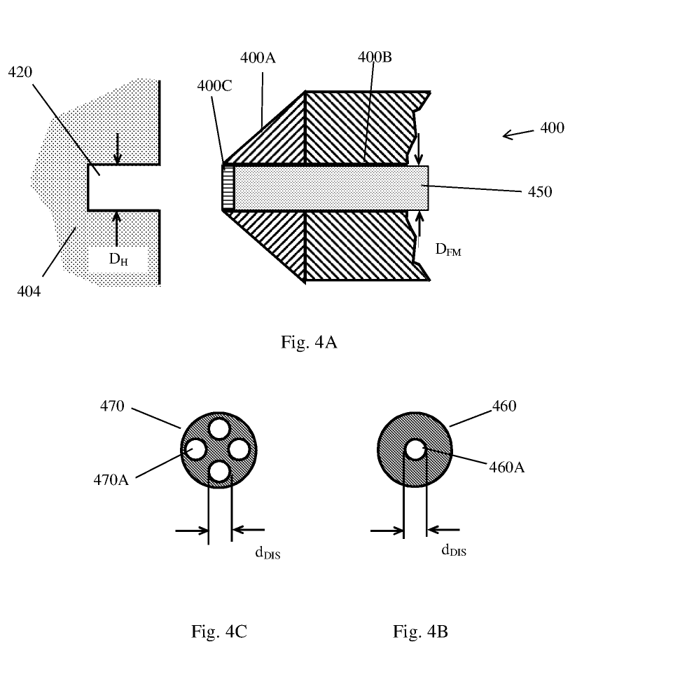

In some embodiments, nozzles 310 and 368 may be an adjustable nozzle, having for example, an adjustable outlet diameter. The outlet diameter may be adjusted by replacing the nozzle (e.g., replaceable nozzles 310 and 368 discussed above), by replacing an element of the nozzle (e.g., a plate as illustrated in FIGS. 4C-4D) or may be adjusted using a shutter or a valve. The adjustable nozzle may be configured to adjust the amount of filling material that is expelled from the outlet.

In some embodiments, filling materials 350A and 350B may be or may have the same properties and characteristics as filling material 220 disclosed above. Filling material 350A or 350B after being provided by application tools 300 and 360, respectively, and hardened may have a module of elasticity of at least 16 MPa. In some embodiments, filling material 350A or 350B may be adapted to harden within 7 minutes after expelling from nozzle 310 or 368 Filling material 350A or 350B may be hardened due to decrease in the temperature of the material after being heated in the preparation unit and/or due to a chemical reaction between different components included in filling materials 350A or 350B.

Typical operation timelines: use of application tool such as application tool 300 may require heating of up to 280 degrees Celsius, with heating power of at least 150 Watts for filling material of type Polycarbonate in order to be able to fill holes of 10 mm diameter and 50 mm depth within ˜5 seconds and cool down time of no more than 30 seconds. Table 1 presenting exemplary filling materials, their mechanical features and their typical application and cool down times is presented below.

Various kinds of filling materials may be used. Their selection should take into account the type of substrate, the size of the bolt, the required working speed and the like. It will be noticed, however, that for a large range of filling materials and holes' inner diameter single configuration hand tool such as tool 300 or tool 360 may be used.

Selection of Filling Material.

Filling material may be selected according to one or more from the following factors comprising required strength, type of substrate, required cooling time, size of hole in the substrate, etc. In table 1 below a number of filling materials are listed along with their respective features, allowing a user to choose the right filling material according to some embodiments of the present invention.

In some embodiments, filling material having at least one polymeric component (such as filling material 220, 350A and 350B) may be included in a magazine. Some exemplary shapes of filling materials and magazines are illustrated in FIGS. 3C-3G. In some embodiments, in order for an initially solid filling material to be soften in preparation unit (by, for example, a heating unit), the filling material may have a shape having surface to volume ratio (i.e., Specific surface area in [m⁻¹]) larger than one (1). For example, the filling material may be continuous elongated thin hollow tub, having a cross section illustrated in FIG. 3C. In yet another example, continuous elongated filling material may have a cross section of a thin rectangle (e.g., a tape) as illustrated in FIG. 3D. In some embodiments, continuous elongated solid filling material may have a shape of a rod (e.g., a circular cross section, not illustrated). An elongated filling material included in a magazine according to embodiments of the invention may have any shape and form having a cross section with ratio of more than one between perimeter and area.

In some embodiments, the elongated initially solid filling material may be folded to form the magazine, for example, magazine 390 illustrated in FIG. 3E. Magazine 390 may include an elongated filling material (e.g., filling material 220 and 350A) folded in a spiral shape. It should be noted that magazine 390 is given as an example only, thus the invention is not limited to any folding or packing arrangement. Elongated filling material, according to embodiments of the invention, may be folded or packed at any desired shape or may be arbitrarily packed. Optionally, magazine 390 may include a housing or cover (not illustrated) for packing the elongated filling material.

In some embodiments, a filling material having specific surface area (surface to volume ratio) larger than one (1) may have a shape of a powder or platelets. FIG. 3F is an illustration of magazine 390A comprising a holding chamber 391 for holding a filling material 392. Initially solid filling material 392 may be in a powder state. FIG. 3G is an illustration of magazine 390B comprising a holding chamber 393 for holding a filling material 394. Initially solid filling material 394 may have a shape of platelets. In some embodiments, holding chambers 391 and 392 may include inlets for the insertion of powder material 392 or platelets 394. In such case, advancement unit 324 may include a piston or a screw to feed the filling material to cylinder 316 to be heated by heating elements 322. Holding chambers 391 and 393 may include an outlet for expelling filling material in the flowing state out of holding chambers 391 and 393. Some exemplary initially solid filling materials according to embodiments of the invention are listed below. The initially solid filling materials may be provided to an application tool, such as tool 300 in a magazine having the form of an elongated strip having various cross sections, powder or platelets included in a magazine holding chamber (e.g., housing). The various filling materials may be selected according to their properties, for example, the glass transition temperature (Tg), the shear modulus and the chemical resistance. In some embodiments, after hardening the filling material (e.g., materials 220, 350A or 350B) included in the magazine may have a module of elasticity of at least 16 MPa.

TABLE 1

| | | Melt | Cooling | Glass- | Shear | Shear | | |
|---|---|---|---|---|---|---|---|---|
| | | temp. | time | Transition | modulus | strength | Chemical | |
| Material | MFI | [° C.] | [sec.] | [Tg] | [psi] | [psi] | Resistance | Polymer |
| PC | >30 | 240-300 | <30 | 145 | 114000 | 10000 | Poor | Polycarbonate |
| PET | >30 | 220-280 | <30 | 58 | 240000 | 8000 | Good | Polyethylene |
| | | | | | | | | terephthalate |
| PP | >30 | | <30 | −14 | | 5801 | Good | Polypropylene |
| EVA | >30 | 150-200 | <30 | 58 | N.A | N.A | Good | Ethylene Vinyl |
| | | | | | | | | Acetate |
| HDPE | >30 | | <30 | −90 | | 2175 | Good | High-density |
| | | | | | | | | polyethylene |
| LDPE | >30 | | <30 | −110 | N.A | N.A | Good | Low-density |
| | | | | | | | | polyethylene |
| ABS | >30 | 210-270 | <30 | 105 | 14000 | 5800 | Poor | Acrylonitrile- |
| | | | | | | | | Butadiene |
| | | | | | | | | Styrene |
| PA | >30 | | <30 | 58 | 0.0458 | 15000 | Good | Polyamide |
| | | | | | | | | Nylon6,6 |

Some additional properties according to embodiments of the invention may include the period of time taken for the filling material (e.g., material 220, 350A or 350B) to be hardened. In some embodiments, the filling material included in the magazine (e.g., magazine 390, 390A, 390B and 370) may harden after no more than 7 minutes following the application of the filling material. For example, the filling material may be hardened after 1-5 minutes, 0.5-3 minutes or less. In some embodiments, the filling material may include at least one of a thermosetting polymer and thermoplastic polymer, for example, the polymers listed in table 1. Some additional properties of the filling material may include having a hardness level between 90D to 60A.

In some embodiments, the filling material (e.g., materials 220, 350A or 350B) may have an elasticity level that enables the insertion of the insert after the filing material hardens, for example, in the hole. In some embodiments, the filling material (e.g., material 220, 350A or 350B) after being expelled from the application tool (e.g., tool 300 or 360) may have viscosity level that enables the insertion of the insert to the filling material prior to a complete hardening of the filling material. During the insertion of the insert (e.g., insert 206) the filling material may be elastically pushed towards the wall of the hole (e.g., hole 202) thus further tightening the filling material inside the hole.

In some embodiments, the filling material (e.g., materials 220, 350A or 350B) may have flexibility and deformability that may enable the insertion of an insert while having at least 5% deportability. If the filling material will be too hard it may break or worth cause cracks in the substrate. When inserted into a hole, following by an insertion of an insert, the filling material must have a sufficient degree of deformability (during and/or after hardening) that will not cause any cracks in the substrate.

A filling material (e.g., material 220, 350A or 350B) according to embodiments of the invention may have, after hardening, a strength that may overcome a pulling force. The minimal pulling forces applied may be dependent on the type of the substrate, screw and the diameter of the hole, as presented in Table 2:

TABLE 2

| | | | Maximum |
|---|---|---|---|
| Substrate | Diameter Hole (mm) | Screw size | pulling force (Kg) |
| Sandstone | 6 | ø4 × 35 mm | 259 |
| Gypsum | 6 | ø4 × 35 mm | 20 |
| Wood | 6 | ø4 × 35 mm | 131 |

In some embodiments, after hardening in the hole the filling material (e.g., material 220, 350A or 350B) may have an outer surface facing the wall (e.g., wall 204) that enables painting or covering the filling material with the same paint that covers the wall. The filling material may have good adhesion properties with various types of wall paints.

In some embodiments, filling material may include solid filler component (e.g., in the form of small particles) to form a composite material. For example, filling material may include wood fibers, calcium carbonate, talc, Wollastonite, crushed thermoset plastic and the like. The filler component may increase the strength of the filling material.

Reference is made to FIGS. 4A, 4B and 4C, which schematically illustrate a partial cross section of the dispensing end of an application tool 400 and two different replaceable nozzles 460 and 470, respectively, according to some embodiments of the present invention. Application tool 400 (shown only partially here) may be similar to application tool 300 and may have a dispensing tip 400A forming the end of dispensing duct 400B. Dispensing tip 400A may end with dispensing nozzle 400C Filling material 450 may be advanced through dispensing duct 400B and be heated to near-melting point (or to the melting point) as described in details above. The heated and softened/molten filling material 450 may be dispensed through dispensing nozzle 400C, for example in order to fill installation hole 420 made in substrate 404, as described above. In order to enable satisfying filling of hole 420 with filling material 450, the temperature of filling material should be raised to near melting point. However, once filling material 450 is applied into hole 420, it is desired that filling material 450 will cool down as fast as possible to enable screwing of a bolt into it, so that the bolt is properly fastened and secured. In some embodiments, the insert may be inserted into the filling material before it is fully hardened (full solid) such that the insert may provide additional cooling and it will be inserted easily to the filling material.

In order to enable fast decrease of the temperature of filling material 450 after it is dispensed from tool 400, a few different actions may be taken. The inner diameter of dispensing duct 400B is typically close to and somewhat bigger than the outer diameter D₁ of filling material 450. The diameter of hole 420 is D_{H} and it may be of any size larger than the outer diameter of the bolt to be installed in it. In order to allow for fast cool down of filling material 450, filling material 450 may be dispensed through nozzle 400C which may have dispensing holes with diameter relatively smaller than D_{H} and/or D_{FM}. The rate of dispensing may be accelerated to enable fast enough filling of hole 420. However, the dispensing of filling material 450 through small holes causes the ratio of the surface area of a length unit of dispensed filling material to its mass to grow bigger, thus allowing for faster spontaneous cooling of the dispensed material. When diameter D_{H} is relatively small, nozzle 460, having a single dispensing hole 460A, may be used. Nozzle 460A may have diameter d_{DIs} fulfilling d_{DIs}<D_{H}. When diameter D_{H} is relatively large, nozzle 470 may be used. Nozzle 470 may have several dispensing holes 470A (four in the example of FIG. 4C), each having a diameter d_{DIs} smaller than D_{H}. Such arrangement allows for faster dispensing, along with maintaining a low ratio of surface area to mass, as with nozzle 460, thereby allowing fast cooling of filling material 450.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An application tool for providing filling material, comprising:
a chamber for holding a filling material comprising at least one polymeric component;
a preparation unit configured to prepare the filling material, such that the prepared filling material is in a flowing state;
an advancement unit to controllably cause continuous advancement of the filling material;
a nozzle for providing the flowing filling material out of the application tool; and
a controlling unit configured to:
receive from a user a selected amount of filling material; and
control the advancement unit to feed the selected amount of filling material,
wherein the module of elasticity of the filling material, after being provided by the application tool and hardened, has a value of at least 16 MPa and flexibility and deformability that cause deportability of the hardened filling material of no more than a predefined percentage in response to the insertion of an insert into the hardened filing material.

2. (canceled)

3. The application tool of claim 1, wherein the preparation unit comprises a heating unit for softening the filling material.

4. (canceled)

5. The application tool of claim 1, wherein the filling material comprises a first material having a first polymeric component and a second material having a second polymeric component and wherein the preparation unit comprises a chamber for mixing the first material and the second material to form the flowing filling material.

6. The application of claim 1, wherein the advancement unit is configured to feed the filling material into the preparation unit.

7-8. (canceled)

9. The application tool of claim 1, wherein the advancement unit includes an electrical unit adapted to controllably feed filling material into the preparation unit.

10. The application tool of claim 1, wherein the advancement unit includes a mechanical unit adapted to controllably feed filling material into the preparation chamber.

11. The application toll of claim 1, wherein the nozzle is a replaceable nozzle.

12. The application tool of claim 11, comprising a set of replaceable nozzles, wherein each of the replaceable nozzles has a different outlet diameter.

13-14. (canceled)

15. The application tool of claim 1, wherein the controlling unit includes a trigger.

16. The application tool of claim 1, wherein the controlling unit includes an electrical unit.

17. The application tool of claim 1 wherein the filling material is adapted to harden within 7 minutes after expelling from the nozzle.

18. A magazine comprising a filling material, the filling material:
has at least one polymeric component;
is configured to flow after being treated in a preparation unit included in an application tool; and
has a module of elasticity of at least 16 MPa and flexibility and that cause deportability of the hardened filling material of no more than a predefined percentage in response to the insertion of an insert into the hardened filing material.

19-29. (canceled)

30. A method of fixating an insert to a substrate, comprising:
making a hole in the substrate;
selecting the amount of filling material to be filled into the hole;
filling the hole, up to a desired depth, with the selected amount of filling material in a flowing state, using an application tool for providing filling material, the filling material having at least one polymeric component; and
inserting the insert into the filled hole after the filling material had reached a desired level of hardening,
wherein, the filling material after hardening has a module of elasticity of at least 16 MPa and flexibility and that cause deportability of the hardened filling material of no more than a predefined percentage in response to the insertion of an insert into the hardened filing material.

31-34. (canceled)

35. The method of claim 30, wherein in the length of the hole is smaller than the thickness of the substrate.

36. The method of claim 30, wherein the length of the hole is equal to the thickness of the substrate and the filling material exceeds the end of the hole.
